(19) United States
(12) Patent Application Publication
(10) Pub. No.: US 2026/0209088 A1
(43) Pub. Date: Jul. 23, 2026

(54) WATER CARE SYSTEM, DEVICE, AND METHOD

(71) Applicant: Masterspas, LLC, Fort Wayne, IN (US)

(72) Inventors: Timothy HOSTETLER, Fort Wayne, IN (US); Jim CARDINALE, Fort Wayne, IN (US); Daniel NORENA BUSTAMANTE, Fort Wayne, IN (US); Caleb PATTERSON, Fort Wayne, IN (US); Tracy GILLILAND, Fort Wayne, IN (US); Nathan COELHO, Leo, IN (US)

(21) Appl. No.: 19/458,434

(22) Filed: Jan. 23, 2026

Related U.S. Application Data
(60) Provisional application No. 63/748,698, filed on Jan. 23, 2025.

(51) Int. Cl. C02F 1/461; C02F 103/42

(52) U.S. Cl. CPC C02F 1/46109; C02F 2103/42; C02F 2201/002; C02F 2201/4611; C02F 2201/4612; C02F 2201/4616; C02F 2209/29; C02F 2303/04

(57) ABSTRACT

A water care system, chlorinator device, and method for regulating an amount of sanitizer in salt water contained in a spa or swimming pool. The water care system includes the chlorinator device that generates the sanitizer via electrolysis, a controller for selectively energizing at least two electrodes of the chlorinator device when the quantity of chlorine drops below a predetermined threshold amount, a mounting socket for removably positioning the chlorinator device on the floor or wall of the spa or pool, and a chlorinator connector assembly for quickly and easily connecting and disconnecting the chlorinator device with the power supply of the controller. The method includes a level setting that combines a predetermined power level value, a predetermined zero point value of the sensor signal, and a predetermined pause value so that a user only has to adjust one variable to optimize the system performance of the water care system.

### RELATED APPLICATIONS

The present application claims priority to U.S. Provisional Application Serial Number 63/748,698 filed on January 23, 2025, the entire disclosure of which is incorporated herein by reference in its entirety.

### FIELD

The present disclosure relates to the field of spa and pool equipment. More particularly, the present disclosure relates to systems, devices, and methods for sanitizing spa and pool water.

### BACKGROUND

Various existing spa and pool water care devices and systems are based on the principle of electrolysis, where an electric current is passed through conductive metal plates that are operative as electrodes, which are immersed in saltwater – sodium chloride (NaCl) dissolved in water (H₂O). Electrolysis induces a chemical reaction that separates the sodium, chlorine, hydrogen, and oxygen ions, enabling them to interact and form hydrogen gas (H₂), chlorine gas (Cl₂), hypochlorous acid (HOCl), and Sodium Hypochlorite (NaOCl). Hypochlorous Acid and Sodium Hypochlorite are the two primary components of the sanitizer more commonly known as chlorine. Therefore, the benefit of using electrolysis in a spa or pool is that chlorine is generated directly in the body of water, eliminating the need to manually add chlorine for sanitization.

Some existing spa and pool water care systems and devices have further refined the electrolysis process by introducing a sensor that monitors water conditions. When the sensor detects that the sanitizer level in the water has fallen below the set point, then the electrolysis device will turn on and run a chlorine generation cycle. This method provides improved operation over other electrolysis systems, which typically are either on or off with no ability to detect sanitizer levels.

In any case, there still is a need for further improvements in spa and pool water care systems and devices.

### SUMMARY

Disclosed herein is a water care system for regulating an amount of sanitizer in salt water contained in a spa or swimming pool. In various embodiments, the water care system comprises: a chlorinator device comprising at least two electrodes, which when energized in the salt water, generate the sanitizer via electrolysis; a controller comprising a microprocessor and a power supply, the microprocessor selectively causing the power supply to energize the at least two electrodes of the chlorinator device when the quantity of chlorine drops below a predetermined threshold amount; and a mounting socket for fixedly attaching to a floor or wall of the spa or pool, the mounting socket for removably positioning the chlorinator device on the floor or wall of the spa or pool.

In some embodiments, the water care system further comprises a chlorinator connector assembly for connecting the chlorinator device with the power supply of the controller and disconnecting the chlorinator device from the power supply of the controller.

In some embodiments of the water care system, the chlorinator connector assembly comprises: a bulkhead connector; and a chlorinator connector for releasably connecting with the bulkhead connector; wherein the bulkhead connector is for fixedly attaching to a bulkhead of the spa or pool and electrically connected with the power supply of the controller; and wherein the chlorinator connector is electrically connected with the at least two electrodes of the chlorinator device.

In some embodiments of the water care system, the chlorinator connector comprises a first electrical connector electrically connected with the electrodes and the bulkhead connector comprises a second electrical connector electrically connected to the power supply of the controller, wherein the first and second electrical connectors are configured to connect with one another when the chlorinator connector is connected with the bulkhead connector.

In some embodiments, the water care system further comprises an electrode cable assembly for electrically connecting the bulkhead connector with the power supply of the controller.

In some embodiments of the water care system, the electrode cable assembly comprises a first electrode cable, an electrode cable extension and the second electrode cable.

In some embodiments of the water care system, the chlorinator device further comprises: an electrode tube having first and second open ends and a plurality of water inlet/outlet openings extending through a sidewall of the electrode tube, the electrode tube enclosing the at least two electrodes; and first and second caps each of which closes one of the first and second open ends of the electrode tube; wherein one of the first and second caps includes a projecting locking member.

In some embodiments of the water care system, the mounting socket comprises a locking slot for releasably receiving the locking projection of the one of the first and second caps when the chlorinator device is mounted in the mounting socket, and wherein the projecting locking member and locking slot removably retain the chlorinator device in the mounting socket.

In some embodiments of the water care system, the mounting socket further comprises a tube-shape projection, the tube-shape projection including a detent for fixedly attaching the mounting socket to the floor or wall of the spa or pool.

In some embodiments of the water care system, the electrode tube includes at least one series of a repeating pattern of the openings.

In some embodiments of the water care system, the openings of the at least one series include a single elongated opening that extends transversely relative to a longitudinal axis L of the electrode tube axially followed by two spaced apart elongated openings, which extend transversely to the longitudinal axis of the electrode tube and are each shorter than the single elongated opening.

Further disclosed herein is a chlorinator device for regulating an amount of sanitizer in salt water contained in a spa or swimming pool. In various embodiment, the chlorinator device comprises: at least two electrodes, which when energized in the salt water, generate the sanitizer via electrolysis; an electrode tube having first and second open ends, the electrode tube for enclosing the at least two electrodes; and first and second end caps each of which closes one of the first and second open ends of the electrode tube; wherein one of the first and second caps includes a projecting locking member for releasably engaging a locking slot of a mounting socket that removably positions the chlorinator device on the floor or wall of the spa or pool.

In some embodiments of chlorinator device, the electrode tube includes at least one series of a repeating pattern of the openings.

In some embodiments of the chlorinator device, the openings of the at least one series include a single elongated opening that extends transversely relative to a longitudinal axis L of the electrode tube axially followed by two spaced apart elongated openings, which extend transversely to the longitudinal axis of the electrode tube and are each shorter than the single elongated opening.

In some embodiments, the chlorinator device, further comprises a chlorinator connector of a chlorinator connector assembly, the chlorinator connector assembly for connecting the chlorinator device with a power supply of a controller and disconnecting the chlorinator device from the power supply of the controller.

In some embodiments of the chlorinator device, the chlorinator connector is electrically connected with the at least two electrodes of the chlorinator device.

In some embodiments of the chlorinator device, the chlorinator connector is configured for releasably connecting with a bulkhead connector of the chlorinator connector assembly which is electrically connected with the power supply of the controller.

In some embodiments of the chlorinator device, the chlorinator connector includes a first electrical connector electrically connected with the electrodes, the first electrical connector for connecting with a second electrical connector of the bulkhead connector when the chlorinator connector is connected with the bulkhead connector.

Further disclosed herein is a method for operating the water care system. In various embodiment, the method comprises: inputting into a controller of the water care system a sensor signal indicating a presence or an absence of sanitizer in water of spa or pool; inputting into the controller a selected level setting; inputting into the controller a quantity of an electrolytic compound that is present in the water of the spa or pool; determining with the controller whether the sensor signal has fallen below a predetermined sensor signal value of the level setting, wherein if the sensor signal has fallen below a predetermined sensor signal value of the level setting there is the absence of sanitizer in water of spa or pool and if the sensor signal is above a predetermined sensor signal value of the Level setting there is the presence of sanitizer in water of spa or pool; determining with the controller whether the quantity of the electrolytic compound in the water of the spa or pool is within an acceptable range for electrolysis; and if the controller determines that the sensor signal has fallen below a predetermined sensor signal value of the level setting and the quantity of the electrolytic compound in the water of the spa or pool is within the acceptable range, then the controller causes a chlorinator device of the water care system to commence electrolysis for a duration of a sanitizer production cycle defined as part of the selected Level setting.

In some embodiments, the method further comprises causing the chlorinator device to stop sanitizer production with the controller if the duration of the sanitizer production cycle has ended.

In some embodiment, of the method, the selected level setting comprises a predetermined power level value, a predetermined zero point value of the sensor signal, and a predetermined pause value.

In some embodiments, the method further comprises if the controller determines that the sensor signal above a predetermined sensor signal value of the level setting, the controller will not cause the chlorinator device to commence electrolysis for a duration of the sanitizer production cycle defined as part of the selected Level setting.

In some embodiments the method further comprises if the controller determined that the quantity of the electrolytic compound in the water of the spa or pool is not within the acceptable range, then the controller will not cause the chlorinator device to commence electrolysis for the duration of a sanitizer production cycle defined as part of the selected Level setting.

### BRIEF DESCRIPTION OF THE DRAWING

The disclosure is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and the drawing.

FIG. 1A is a schematic diagram of an illustrative embodiment of a water care system 100 of the present disclosure.

FIG. 1B is an exploded perspective view of an illustrative embodiment of a digital controller of the present disclosure.

FIG. 1C is an illustrative embodiment of a filter compartment of a spa, which depicts a chlorinator device of the water care system of the present disclosure mounted on a spa shell floor and wall of the filter compartment of the spa.

FIG. 2A is a perspective view of an illustrative embodiment of a chlorinator device of the present disclosure attached to an illustrative embodiment of a first electrode cable of an electrode cable assembly of the present disclosure.

FIG. 2B is an exploded elevation view of the chlorinator device of FIG. 2A.

FIG. 2C is a perspective view of a top end cap of the chlorinator device of FIG. 2A, according to an illustrative embodiment of the present disclosure.

FIG. 2D is an elevation view of the top end cap of FIG. 2C.

FIG. 2E is a sectional view through line 2E-2E of the top end cap shown in FIG. 2D.

FIG. 3A is a front elevation view of an electrode tube of the chlorinator device of FIG. 2A, according to an illustrative embodiment of the present disclosure.

FIG. 3B is a side elevation view of the electrode tube of FIG. 3A.

FIG. 3C is a rear elevation view of the electrode tube of FIG. 3A.

FIG. 4A is a perspective view of a bottom end cap of the chlorinator device of FIG. 2A, according to an illustrative embodiment of the present disclosure.

FIG. 4B is a top view of the bottom end cap of FIG. 4A.

FIG. 4C is an elevation view of the bottom end cap of FIG. 4A.

FIG. 4D is a sectional view through line 4D-4D of the bottom end cap shown in FIG. 4C.

FIG. 5A is a perspective view of a chlorinator mounting socket, according to an illustrative embodiment of the present disclosure.

FIG. 5B is a top view of the chlorinator mounting socket of FIG. 5A.

FIG. 5C is a bottom view of the chlorinator mounting socket of FIG. 5A.

FIG. 5D is an elevation view of the chlorinator mounting socket of FIG. 5A.

FIG. 5E is a sectional view through line 5E-5E of the chlorinator mounting socket shown in FIG. 5D.

FIG. 6A is a front elevation view the chlorinator device of FIG. 2A mounted in the chlorinator mounting socket of FIG. 5A, when the chlorinator mounting socket is installed through an opening in a spa shell floor of a filter compartment of a spa according to an illustrative embodiment of the present disclosure.

FIG. 6B is a side elevation view the chlorinator device of FIG. 2A mounted in the chlorinator mounting socket of FIG. 5A, when the chlorinator mounting socket is installed through an opening in a spa shell floor of a filter compartment of a spa, according to an illustrative embodiment of the present disclosure, which illustrates the bottom cap and chlorinator mounting socket in partial cross-section.

FIGS. 6C and 6D collectively illustrate how the chlorinator mounting socket shown in the sectional view of FIG. 5E is socket is installed through an opening in a spa shell floor of a filter compartment of a spa according to an illustrative embodiment of the present disclosure.

FIG. 7A is a front elevation view of the chlorinator device of FIG. 2A.

FIG. 7B is a side elevation sectional view of the chlorinator device of FIG. 2A illustrating male and female electrode cable connectors of a chlorinator connector assembly connected together, according to an illustrative embodiment of the present disclosure wherein the female electrode cable connector is connected to the first electrode cable of the electrode cable assembly according to an illustrative embodiment of the present disclosure.

FIG. 7C is a side elevation view of the chlorinator device of FIG. 2A illustrating the male electrode cable connector, the female electrode cable connector and the first electrode cable illustrated in FIG. 7B disconnected from one another.

FIG. 7D is an enlarged view of area 7D of FIG. 7B illustrating the male and female electrode cable connectors of the chlorinator connector assembly connected together.

FIG. 7E is a side sectional view of the male electrode cable connector and the female electrode cable connector disconnected from one another.

FIG. 7F is an enlarged view of area 7F of FIG. 7E illustrating the male and female electrode cable connectors of the chlorinator connector assembly disconnected from one another.

FIG. 7G is a front view of the male electrode cable connector of the chlorinator connector assembly.

FIG. 7H is a front view of the female electrode cable connector of the chlorinator connector assembly.

FIG. 7I is a side view of the first electrode cable of the electrode cable assembly of the present disclosure.

FIG. 8 is a flowchart representing an illustrative embodiment of a method for operating the water care system of the present disclosure.

### DETAILED DESCRIPTION

It should be understood that the phraseology and terminology used below for the purpose of description and should not be regarded as limiting. The use herein of the terms “comprising,” “including,” “having,” “containing,” and variations thereof are meant to encompass the structures and features recited thereafter and equivalents thereof as well as additional structures and features. Unless specified or limited otherwise, the terms “attached,” “mounted,” “affixed,” “connected,” “supported,” “coupled,” and variations thereof are used broadly and encompass both direct and indirect forms of the same.

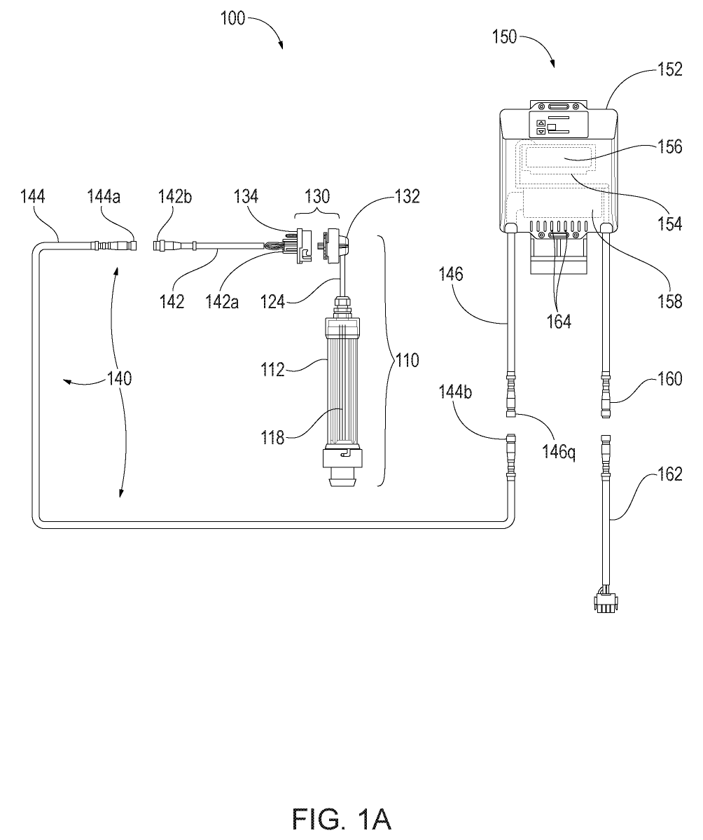

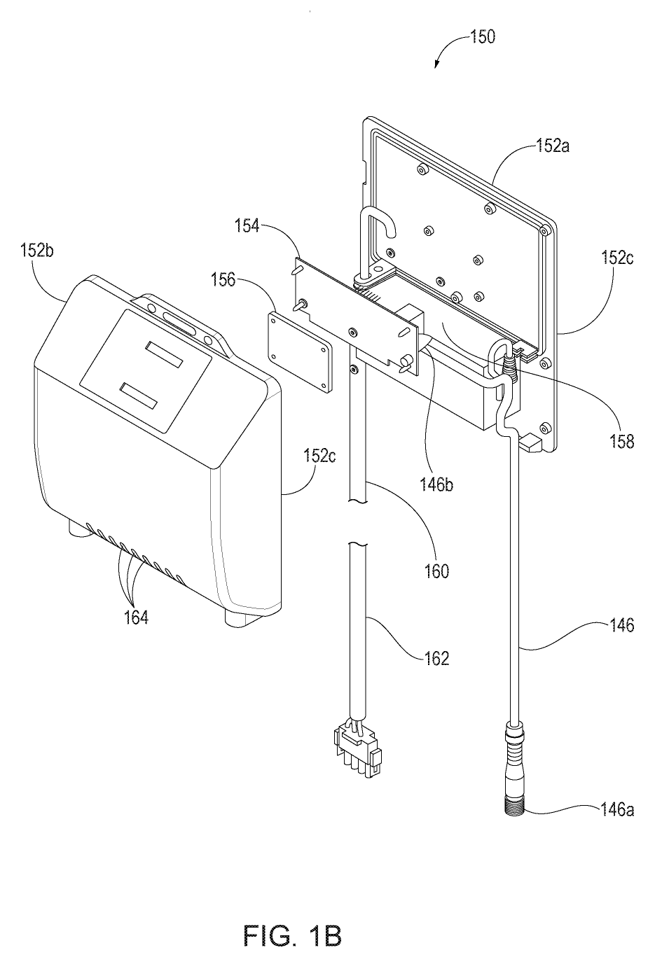

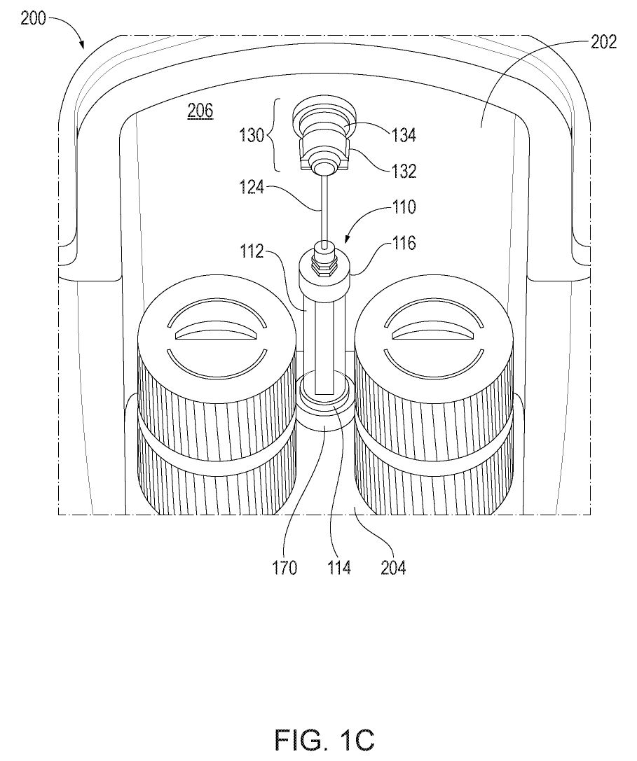

FIG. 1A is an illustrative embodiment of a water care system 100 of the present disclosure. The water care system 100 is intended for regulating the amount of a salt-originated sanitizer in the water contained in a hot tub spa, cold tub spa, or a swim spa (hereinafter spa), or swimming pool. The water care system comprises an electrolysis/chlorinator device 110 (chlorinator device 110) and a remotely located digital controller 150. As illustrated in FIG. 1C, the chlorinator device 110 of the water care system 100 of the present disclosure, is configured to be removably mounted on a spa shell floor 204 of a filter compartment 202 of the spa 200, or on the floor or wall of a swimming pool (not shown).

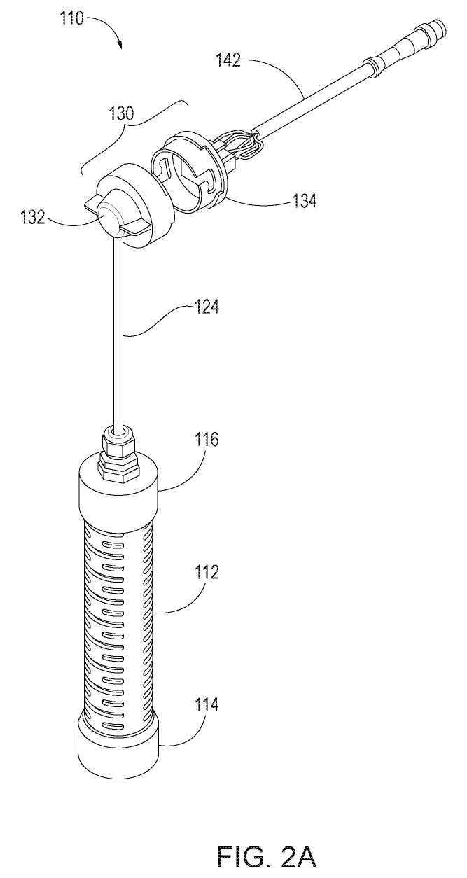

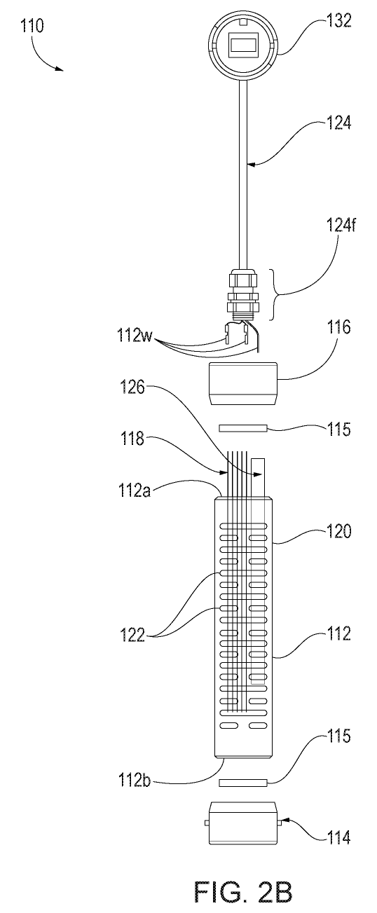

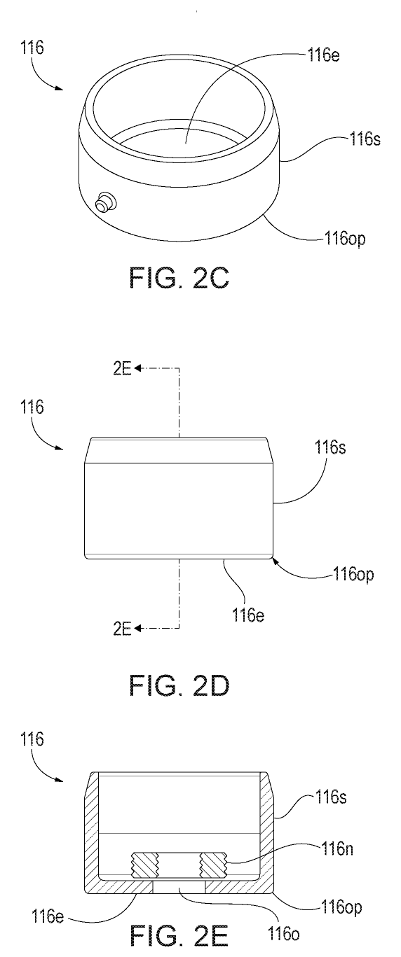

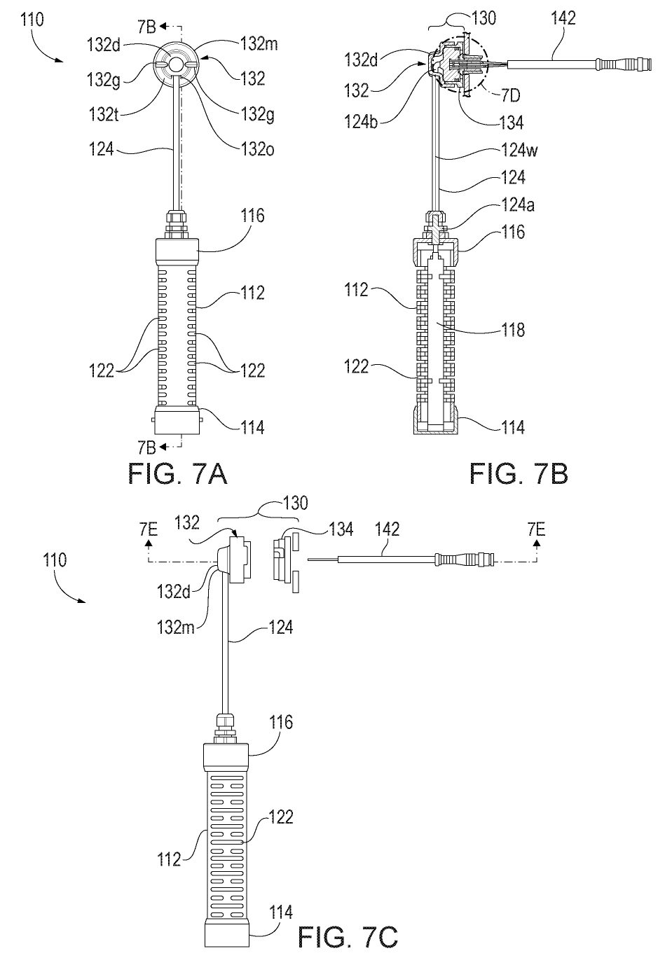

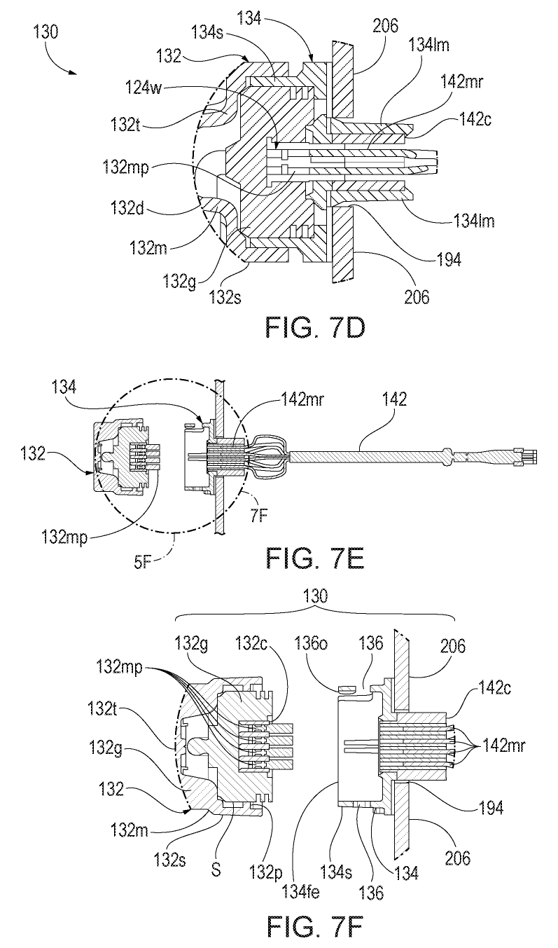

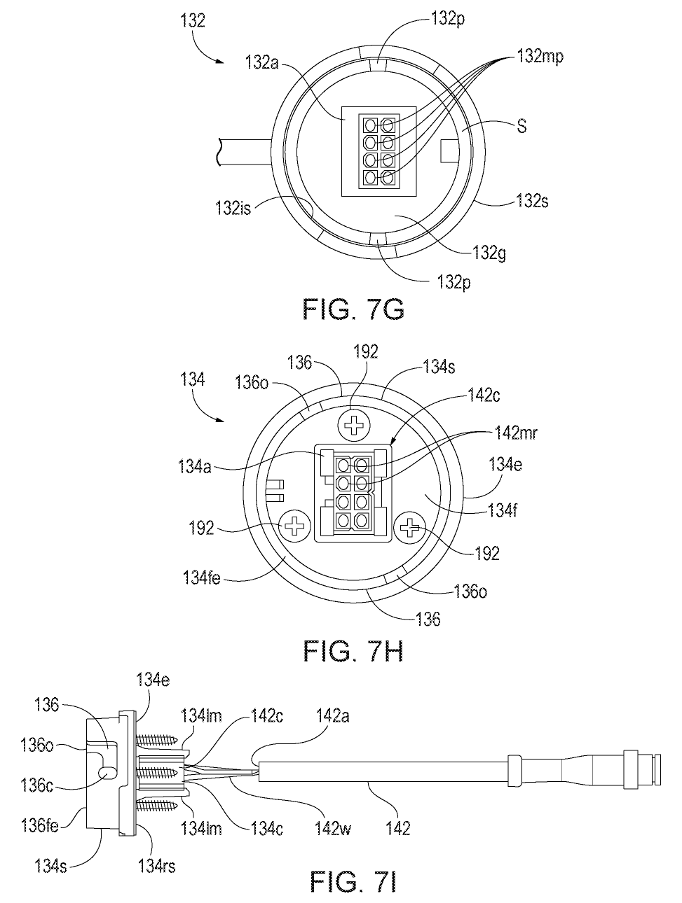

Referring still to FIG. 1A, the chlorinator device 110 comprises an electrode tube 112 and two or more spaced apart metal plates 118, which are operative as electrodes and are enclosed by the electrode tube 112. The electrode tube 112 includes a plurality of water inlet/outlet openings 122 (see, for example, FIG. 2B) in a sidewall 120 thereof, which extend into interior of the electrode tube 120 to allow water to move in and out of the electrode tube 112. The chlorinator device 110 further comprises a chlorinator electrical connection harness 124 and a male electrode cable connector 132 (hereinafter chlorinator connector 132) of a chlorinator connector assembly 130. As shown in FIG. 7B, the chlorinator electrical connection harness 124 includes opposing first and second ends 124a, 124b and electrical wires 124w that extend therethrough from the first end 124a to the second end 124b of the harness 124. The electrical wires at the first end 124a of the harness 124 are mechanically and electrically coupled to the electrodes 118, and the electrical wires at the second end 124b of the harness 124 are mechanically and electrically coupled to a plurality of metal electrical connection pins 132mp of a conventional male electrical connector 132c (e.g., FIG. 7G) of the chlorinator connector 132, thereby electrically connecting the electrodes 118 of the chlorinator device 110 to the chlorinator connector 132 of the chlorinator connector assembly 130.

As collectively shown in FIGS. 1A and 1B, in one illustrative embodiment the digital controller includes a housing 152 that contains a circuit board 154, a microprocessor 156, a power supply 158, a second electrode cable 146 of an electrode cable assembly 140, a power cable 160, and a power cable extension 162. The microprocessor 156 executes programming logic, which controls the chlorinator device 110 by selectively causing the power supply 158 to energize and de-energize the electrodes 118 of the chlorinator device 110 based on how much sanitizer/chlorine is contained in the water of the spa or swimming pool. The control box housing 152 includes a rear panel 152a and front cover 152b. The circuit board 154 is mounted on an inner surface of the front cover 152b and the microprocessor 156 is mounted on the circuit board 154 in manner that allows two-way electrical/data communication therebetween. The power supply 158 is also mounted on the front cover 152b and is electrically and mechanically coupled to the power cable 160, and supplies power to the circuit board 154 and the microprocessor 156. The second electrode cable 146 is electrically coupled with the power supply 158. The housing 152 is configured to maintain a required waterproof rating, but allows for adequate ventilation by providing vents openings 164 at the bottom of the front cover 152b of the housing 152 to prevent overheating and premature failure of the microprocessor 156, the circuit board 154 and the power supply 158. Providing the vent openings 164 at the bottom of the front cover 152b substantially prevents water falling vertically or sideways from entering the vents openings 164. In addition, a gasket and/or o-ring and/or a liquid sealant like silicone (not shown), is provided at a peripheral edge 152c of the housing 152 between the rear panel 152a and the front cover 152b to seal the peripheral edge 152c of the housing 152. Other non-limiting embodiments of the digital controller may further include a heat sink (not shown) to absorb heat, thereby providing further cooling of the microprocessor 156, the circuit board 154 and the power supply 158.

Referring still to FIG. 1A, the electrodes 118 of the chlorinator device 110 are electrically connected to the power supply 158 of the digital controller 150 with the earlier mentioned electrode cable assembly 140, which enables the digital controller 150 to transmit the aforementioned electric current to the electrodes 118. The electrode cable assembly 140 includes a first electrode cable 142, an electrode cable extension 144 and the second electrode cable 146.

The first electrode cable 142 includes opposing first and second ends 142a, 142b and electrical wires (not visible) that extend therethrough from the first end 142a to the second end 142b of the first electrode cable 142. The electrical wires at the first end 142a of the first electrode cable 142 are mechanically and electrically coupled to a plurality of metal electrical connection pin receptacles 142mr contained in a conventional female electrical connector 142c that is attached to a female electrode cable connector 134 (hereinafter bulkhead connector 134) (see, for example, FIG. 7H) of the chlorinator connector assembly 130. The electrical wires at the second end 142b of the first electrode cable 142 are mechanically and electrically coupled to wires (not visible) at a first end 144a of the electrode cable extension 144 using conventional male/female electrical connectors. The wires of the electrode cable extension 144 extend therethrough to a second end 144b of the electrode cable extension 144.

The second electrode cable 146 includes opposing first and second ends 146a, 146b and electrical wires (not visible) that extend therethrough from the first end 146a to the second end 146b of the second electrode cable 146. The electrical wires at the first end 146a of the second electrode cable 146 are mechanically and electrically coupled to the wires at the second end 144b of the electrode cable extension 144 using conventional male/female electrical connectors. The electrical wires at the second end 146b of the second electrode cable 146 are electrically connected with the power supply 158 of the digital controller 150.

The level of sanitizer in the water of the spa or swimming pool is monitored with a chlorine sensor immersed in the water of the spa or swimming pool. The chlorine sensor functions as an electrochemical galvanic cell, which converts the chemical energy of spontaneous redox reactions into electrical energy. In other embodiments, a chlorine sensor is configured to measure the oxidation-reduction potential (ORP) of the water to determine the sanitization potential of the water. The microprocessor 156 of the controller 150 is electrically coupled with the remotely located chlorine sensor (not shown) immersed in the water of the spa or swimming pool and, thus, monitors changes in the electrical energy readings. Hence the controller 150, via the chlorine sensor, can detect when sanitizer is needed in the water. In the embodiment illustrated in FIG. 2B, the chlorinator device 110 further includes a chlorine sensor 126, which is enclosed by the electrode tube 112. In this embodiment, the chlorinator electrical connection harness 124, the chlorinator and bulkhead connectors 132, 134 of the chlorinator connector assembly 130, and the components 142, 144, and 146 of the electrode cable assembly 140 further include sensor wiring (not shown) that electrically connects the chlorine sensor 126 of the chlorinator device 110 with the microprocessor 156 of the controller 150

In operation, the chlorinator device 110 is submerged in saltwater (sodium chloride (NaCl) dissolved in water (H₂O)) contained in the spa or swimming pool, (e.g., spa shown in FIG. 1C). The openings 122 (FIG. 2B) in the sidewall 120 of the electrode tube 112 allow the saltwater (hereinafter water) to flow into the electrode tube 112 and contact the electrodes 118. If the microprocessor 156 of the controller 150 determines, from the electrical energy signals received by the chlorine sensor (e.g., sensor 126 shown in FIG. 2B) that sanitizer needs to be added to the water in the spa or swimming pool, the microprocessor 156 activates the power supply 158, which in turn, generates an electric current that is transmitted by the electrode cable assembly 140 and the chlorinator electrical connection harness 124, to the electrodes 118 of the chlorinator device 110. Consequently, the energized electrodes 118 induce a chemical reaction referred to as electrolysis, which separates the sodium, chlorine, hydrogen, and oxygen ions of the saltwater, thereby enabling them to interact and form hydrogen gas (H₂), chlorine gas (Cl₂), hypochlorous acid (HOCl), and Sodium Hypochlorite (NaOCl). Hypochlorous Acid and Sodium Hypochlorite are the two primary components of the sanitizer more commonly known as chlorine. The chlorine generated by electrolysis within the electrode tube 112 of the chlorinator device 110, flows out of the openings 122 in the sidewall 120 of the electrode tube 112 and into the saltwater of the spa or swimming pool thereby sanitizing the saltwater. If the microprocessor 156 of the controller 150 determines, from the electrical energy signals received by the chlorine sensor, that sanitizer no longer needs to be added to the water in the spa or swimming pool, the microprocessor 156 deactivates the power supply 158, which in turn, de-energizes the electrodes 118 of the chlorinator device 110, thereby ending the electrolysis reaction inside the electrode tube 112 of the chlorinator device 110. Accordingly, the benefit of using electrolysis in a spa or swimming pool is that chlorine is generated directly in the body of water, eliminating the need to manually add chlorine for sanitization.

FIGS. 2A and 2B collectively illustrate the structural details of the chlorinator device 110 according to an embodiment of the present disclosure. The chlorinator device 110 comprises earlier described electrode tube 112, which is typically made of a transparent Polyvinyl Chloride (PVC). The electrode tube 112 is configured as a hollow cylinder of circular cross-section, which defines the earlier mentioned sidewall 120. The electrode tube 112 has a first open end 112a closed by a top end cap 116 and an opposing second open end 112b closed by a bottom end cap 114. As shown in FIGS. 2B-2E, the top end cap 116 is formed by a circular end wall 116e and a cylindrical sidewall 116s that extends from an outer periphery 116op of the circular top wall 116e. The end wall 116e includes a central opening 116o (FIG. 2E) for allowing the second end 124b of the chlorinator electrical connection harness 124 to pass therethrough into the top end cap 116, and a nut fastener 116n is affixed to the inner surface of the end wall 116e with its threaded opening coaxial with the opening 116o, for threadedly engaging a correspondingly threaded fastener arrangement 124f at the second end 124b of the chlorinator electrical connection harness 124 (FIG. 2B) and connecting the same to the top end cap 116, and thereby enabling the wires 124w of the chlorinator electrical harness to pass through the top end cap 116 and connect with the electrodes 118 in the electrode tube 112.

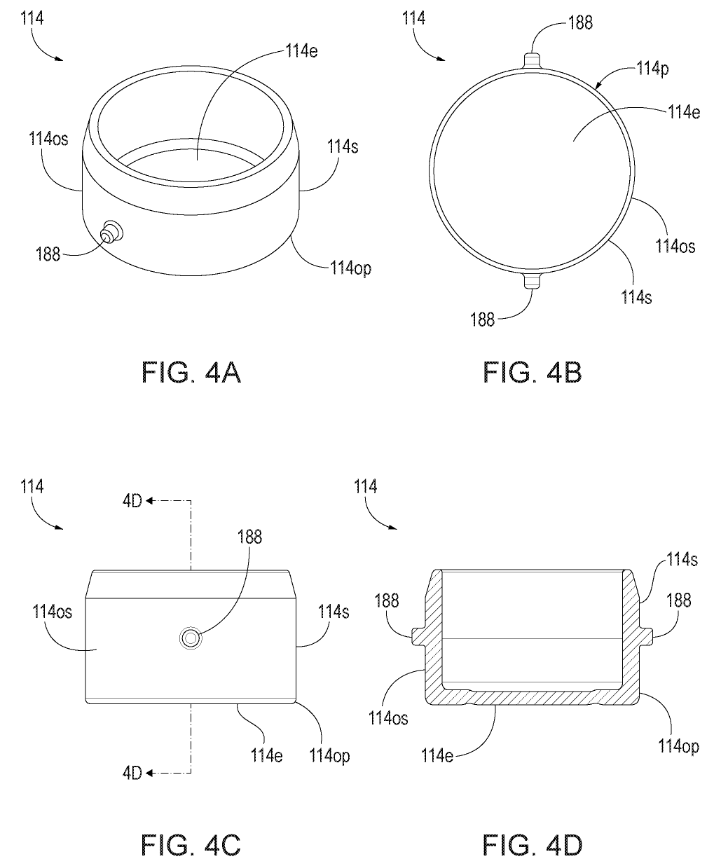

As shown in FIGS. 4A-4D, the bottom end cap 114 has essentially the same structure as the top end cap 116 in that the bottom end cap 114 has a circular end wall 114e and a cylindrical sidewall 114s that extends from an outer periphery 114op of the circular end wall 114e. As shown in FIG. 2B, spacers slid part way down over the electrodes and the chlorine sensor 126 are a pair of spacers 115. The spacers 115 hold the electrodes 118 parallel to one another, so they will not make contact with each other (which would short circuit the electrolysis reaction), and to make the electrolysis reaction more efficient. The spacers 115 also hold the chlorine sensor 126 in place. The inner diameter of the cylindrical sidewall 116s, 114s of each of the top and bottom end caps 116, 114 is sized to respectively receive the first and second open ends 112a, 112b of the electrode tube 112. The openings 122 in the sidewall 120 of the electrode tube 112 are only provided in the portion of the sidewall 120 that extends between the top and bottom end caps 116, 114.

In existing chlorinators, the electrode tube includes slot-shaped openings formed lengthwise in the sidewall of the electrode tube that allow the saltwater contained in the spa or swimming pool to: 1) flow into the electrode tube and contact the electrodes contained therein; and then 2) allow water containing the sanitizer/chlorine outputs of the chemical reaction generated between the energized electrodes and the saltwater, to flow away from the electrodes and out of the electrode tube and into the spa or swimming pool. However, most of the water-sanitizer/chlorine outputs of the chemical reaction flow out of the electrode tube from the top portions of the slots of the electrode tube. This is because the chemical reaction and the resulting sanitizer/chlorine outputs tend to concentrate and collect around the top of the chlorinator, leading to premature degradation and failure of the components at the top of the chlorinator. In addition, the concentration of the sanitizer/chlorine outputs collects around the chlorine sensor, which is located inside the upper portion of the electrode tube in some embodiments, and can lead to false readings.

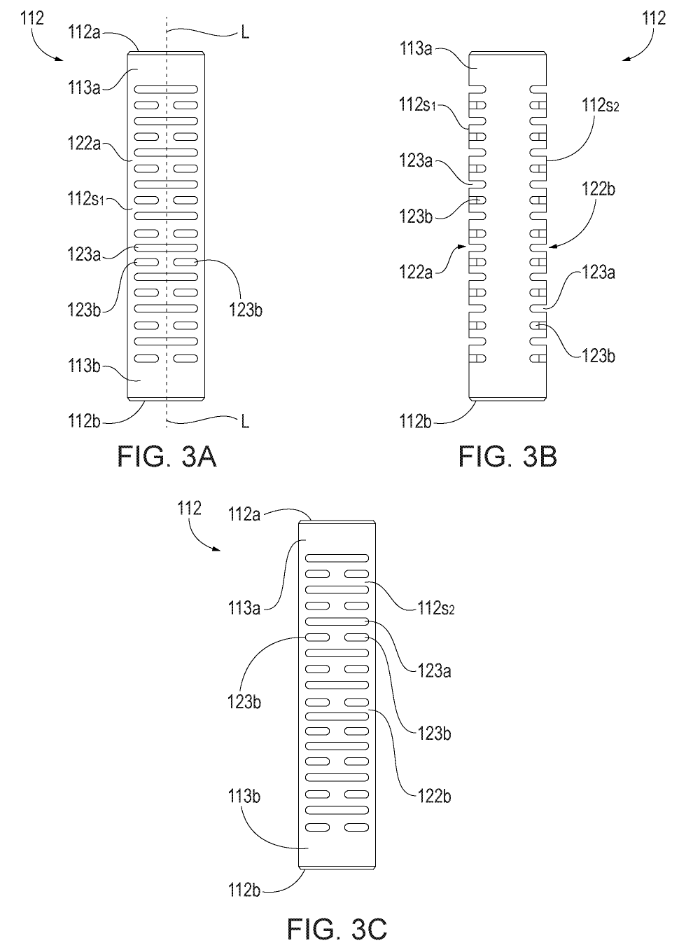

The chlorinator device 110 of the present disclosure solves the problems mentioned immediately above with existing chlorinators, by providing an electrode tube 112 with the water inlet/outlet openings 122 in the sidewall 120 thereof that extend into the interior of the electrode tube 112 and which are configured as illustrated in the embodiment of FIGS. 3A-3C. In particular, the openings 122 in the sidewall 120 of the electrode tube 112 of the present invention are configured by a first series of openings 122a formed on a first side 112s1of the electrode tube sidewall 120, as shown in FIG. 3A and a second series of openings 122b formed on the opposite side 112s2 of the electrode tube sidewall 120, as shown in FIG. 3C. Each of the first and second series of openings 122a, 122b extend between first and second marginal end 113a, 113b surfaces of the electrode tube 112, as the first and second marginal end surfaces 113a, 113b of the electrode tube 112 will reside inside their respective top and bottom end caps 116, 114 when the top and bottom end caps 116, 114 are installed on the first and second open ends 112a, 112b of the electrode tube 112. Each of the first and second series of openings 122a, 122b define a repeating pattern comprising a single elongated opening 123a that extends transversely relative to the longitudinal axis L of the electrode tube 112 axially followed by two spaced apart elongated openings 123b_{,} which extend transversely to the longitudinal axis L of the electrode tube 112 and are each shorter than the single elongated opening 123a. The first and second series of openings 122a, 122b in the sidewall 120 of the electrode tube 112 are configured for optimized water flow and greater water sanitizer/chlorine dissipation efficiency and each of the openings 122 in one non-limiting embodiment, has a width of about 3/16 of an inch, so that a user cannot touch the electrodes 118 contained inside the electrode tube 112 with the user’s fingers. The improved flow provided by the electrode tube 112 of the chlorinator device 110 of the present invention significantly reduces the potential negative consequences that can occur when the sanitizer/chlorine outputs of the chemical reaction inside the electrode tube 112 collect around the top of the interior of electrode tube 112 (premature component degradation/failure and false sensor readings). In addition, the handling of the chlorinator device 110 is safer due to the openings 122a, 122b in the sidewall 120 of the electrode tube 112 being sized to prevent a user from touching the electrodes 118 contained inside the electrode tube 112. In other embodiments, the electrode tube 112, includes only one series of openings (series 122a or 122b), which define a repeating pattern comprising a single elongated opening 123a that extends transversely relative to the longitudinal axis L of the electrode tube 112 axially followed by two spaced apart elongated openings 123b_{,} which extend transversely to the longitudinal axis L of the electrode tube 112 and are each shorter than the single elongated opening 123a.

Existing chlorinator devices are designed to be placed in the main body of water. However this method does not provide the look and feel that is desired for an integrated OEM installation. More importantly, this method does not keep the chlorinator device anchored in place, so it can be bounced around by the turbulent water movement in a spa or swimming pool and potentially cause damage to the chlorinator device and/or spa or swimming pool surfaces.

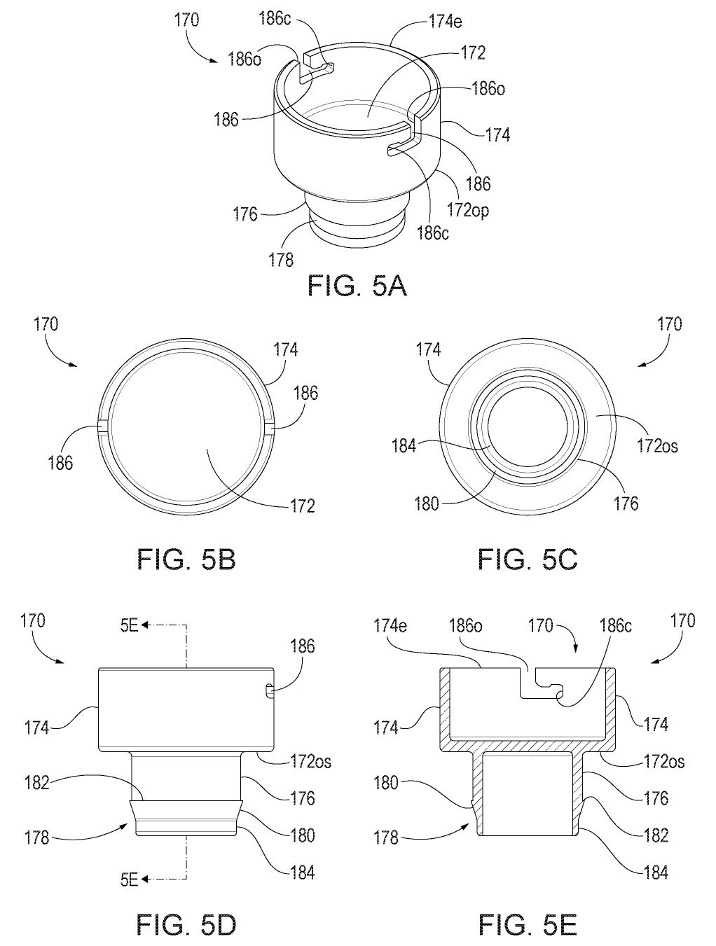

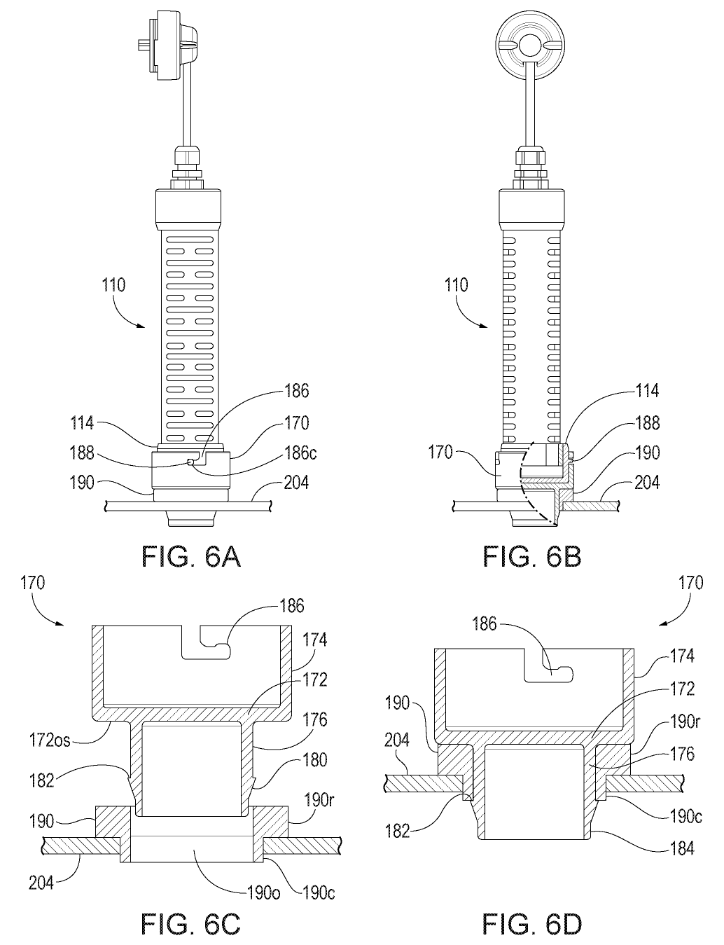

In order to prevent the chlorinator device 110 from bouncing around in turbulent water and to make the chlorinator device 110 easily accessible for inspection and replacement, a chlorinator mounting socket 170 is provided in accordance with the present disclosure. In one illustrative embodiment, as shown in FIGS. 5A-5E, the chlorinator mounting socket 170 is configured to be fixedly attached to the spa shell floor 204 of the filter area 202 of the spa 200 (FIG. 1C) or the floor or wall of a swimming pool (not shown). The chlorinator mounting socket 170 is further configured to receive and securely mount the chlorinator device to the spa shell floor 204 of the filter area 202 of the spa 200 (FIG. 1C) or the floor or wall of a swimming pool (not shown). More specifically, the chlorinator mounting socket 170 illustrated in FIGS. 5A-5E is formed by a circular end wall 172, a cylindrical sidewall 174 that extends from an outer periphery 172op of the circular end wall 172, and a tube-shape projection 176 depending from an outer surface 172os of the end wall 172. The terminal end of the tube-shape projection 176 defines a retaining means 178 comprising, in one non-limiting embodiment, an annular locking hook 180. The tube-shaped projection extends through a circular opening (not shown) provided in the spa shell floor 204 or the floor or wall of a swimming pool, in order to lock the chlorinator mounting socket 170 in the spa shell floor 204 or swimming pool floor or wall. The annular locking hook 180 has a frustoconical-shape (FIG. 5D) that tapers down to a ring-shaped lead-in portion 184 and defines an upper annular abutment surface 182. The sidewall 174 of the chlorinator mounting socket 170 has a pair of J-shaped locking slots 186. The locking slots 186 are disposed about 180 degrees opposite to one another in the mounting socket sidewall 174. Each of the J-shaped locking slots 186 includes an open end 186o and a closed end 186c. The open ends 186o of the locking slots 186 are formed in a peripheral free edge 174e of the mounting socket sidewall 174. As shown in FIGS. 6C and 6D, the chlorinator mounting socket 170 is used with an annular rubber gasket 190 for retaining the chlorinator mounting socket 170 in the opening provided in the spa shell floor 204 or the floor or wall of the swimming pool for mounting the chlorinator mounting socket 170. The gasket 190 also provides a seal that prevents water from passing through the opening in spa shell floor 204 or the floor or wall of the swimming pool, when the chlorinator mounting socket 170 is installed therein. The gasket 190 has a ring-like portion 190r and collar portion 190c that depends from an inner periphery of the collar portion 190c and defines a central opening 190o. When installing the chlorinator mounting socket 170 in the opening of spa shell floor 204 or the floor or wall of the swimming pool, the gasket 190 is first inserted down into the opening as shown in FIG. 6C, such that the collar portion 190c of the gasket 190 extends through the floor or wall opening and the ring-like portion 190r of the gasket 190 rests on a portion of the exterior surface of the spa shell floor 204 or the floor or wall of the swimming pool immediately surrounding the opening. Then, as shown in FIG. 6D, the tube-shape projection 176 of the chlorinator socket 170 is inserted down through the central opening 190o of the gasket 190 and thus, through the opening of the spa shell floor 204 or the floor or wall of the swimming pool, so that the outer surface 172os of the chlorinator socket end wall 172 abuts against the ring-like portion 190r of the gasket 190 and the annular abutment surface 182 is below the collar portion 190c of the gasket 190. The gasket 190 therefore operates as a seal to prevent water from passing through the opening in spa shell floor 204 or the floor or wall of the swimming pool, when the chlorinator mounting socket 170 is installed therein, and the annular abutment surface 182, which has a slightly larger diameter than the collar portion 190c of the gasket 190, retains the chlorinator socket 170 in the opening of the spa shell floor 204 or the floor or wall of a swimming pool when the chlorinator device 110 is mounted therein and when removing/replacing the chlorinator device 110.

Referring again to FIGS. 4A-4D, the bottom end cap 114 of the chlorinator 110 further includes a pair of locking pins 188, which project outwardly from an outer surface 114os of the bottom end cap sidewall 114s. The locking pins 188 are disposed about 180 degrees opposite to one another on the outer surface 114os of the bottom end cap sidewall 114s.

Referring to FIGS. 6A and 6B, the J-shaped locking slots of the chlorinator mounting socket 170 and the locking pins 188 of the bottom end cap 114 of the chlorinator are sized to permit the locking pins 188 to enter, and traverse the length of the locking slots 186, when the chlorinator device 110 is mounted in the chlorinator mounting socket 170, to mount the chlorinator device 110 on the spa shell floor 204 of the filter compartment 202 of the spa 200 (FIG. 1C). To mount the chlorinator device 110 on the spa shell floor 204 of the filter compartment 202 of the spa 200, the locking pins 188 of the bottom end cap 114 of the chlorinator device 110 are aligned with the open ends 186o of the locking slots 186. The chlorinator device 110 is then pressed down into the chlorinator mounting socket 170 so that the locking pins 188 of the chlorinator bottom end cap 114 enter the locking slots 186 through the open ends 186o thereof. The chlorinator device 110 is then rotated a few degrees in the direction of the closed ends 186c of the locking slots 186 so that the locking pins 188 travel towards and abut against the closed ends 186c of the locking slots 186, thereby locking the chlorinator device 110 securely in the mounting socket 170.

One of ordinary skill in the art will recognize that the above-described mounting steps are reversed to remove the chlorinator device 110 from the mounting socket 170 during removal/replacement of the chlorinator device 110 from the filter compartment 202 of the spa 200.

Referring to FIGS. 7A-7I, the chlorinator connector assembly 130 of the chlorinator device 110 described earlier also adds to the look and feel of an integrated OEM installation, and more importantly, enables the chlorinator device 110 to be easily connected to or disconnected from the electrode cable assembly 140, which electrically connects with the digital controller 150. As described earlier and best shown in FIGS. 7C and 7F, the chlorinator connector assembly 130 comprises the chlorinator connector 132 and the bulkhead connector 134. The chlorinator connector 132 includes the earlier mentioned conventional male electrical connector 132c that contains the plurality of metal electrical connection pins 132mp that are mechanically and electrically connected to the electrical wires at the second end 124b of the chlorinator electrical connection harness 124, and a circular rubber gasket 132g over-molded about the male electrical connector 132c (see FIGS. 7D, 7F, and 7G). As best shown in FIGS. 7D and 7I, the bulkhead connector 134 has latched thereto the earlier described conventional female electrical connector 142c of the first electrode cable 142, which contains the plurality of metal electrical connection pin receptacles 142mr that are mechanically and electrically coupled to the electrical wires at the first end 142a of the first electrode cable 142.

Referring still to FIGS. 7A-7I, the chlorinator connector 132 comprises a cap-like member 132m (cap member 132m) formed by a circular top wall 132t and a cylindrical sidewall 132s that extends from an outer periphery 132op of the circular top wall 132t. Top wall 132t includes a dome-shape portion 132d with a side opening 132o (FIG. 7A) for allowing the chlorinator electrical connection harness 124 to extend into the chlorinator connector 132 and through an aperture (not shown) in the rubber gasket 132g (FIGS. 7D and 7F), thereby allowing ends of the wires 124w (FIG. 7D) at second end 124b of the chlorinator electrical connection harness 124, to mechanically and electrically connect with the plurality of metal electrical connection pins 132mp of the conventional male electrical connector 132c. The top wall 132t further includes raised finger gripping members 132g (FIGS. 7A and 7F) on opposite sides of the dome-shaped portion 132d, which allow a user to grip and rotate the cap member 132m relative to the bulkhead connector 134 when connecting the chlorinator connector 132 with the bulkhead connector 134 and disconnecting the chlorinator connector 132 from the bulkhead connector 134. The rubber gasket 132g over-molded about the electrical connector 132 is sized so that a space S (FIGS. 7F and 7G) remains about the rubber gasket 132g between the gasket 132g and the cap member sidewall 132s for receiving a cylindrical sidewall 134s of the bulkhead connector 134 and allowing the cap member 132m to be rotated relative to the rubber gasket 132g over-molded about the electrical connector 132. The sidewall 132s of the cap member 132 includes a pair of locking pins 132p, which project inwardly from an inner surface 132is of the sidewall 132s. The locking pins 132p are disposed about 180 degrees opposite to one another on the inner surface 132is of the cap member sidewall 132s.

Referring still to FIGS. 7A-7I, the bulkhead connector 134 is configured with a circular end wall 134e and a cylindrical sidewall 134s that extends from a front surface 134f (FIG. 7H) of the circular end wall 133e. The end wall 134e includes an aperture 134a (FIG. 7H) for accessing a front portion of the conventional female electrical connector 142c, which contains the plurality of metal electrical connection pin receptacles 142mr that are mechanically and electrically coupled to the electrical wires 142w (FIG. 7D and 7I) at the first end 142a of the first electrode cable 142 (FIG. 7I). As shown in FIGS. 7D and 7I, the end wall 134e includes a pair of cantilever locking members 134lm that project rearwardly from a rear side 134rs of the end wall 134e. The cantilever locking members 134lm are operative for latching the female electrical connector 142c to the bulkhead connector end wall 134e so that the female electrical connector 142c does not get pushed out of the bulkhead connector 134 when being connected to the electrical connection pins 132p of the male electrical connector 132c of the chlorinator connector 132. A plurality of apertures (not visible) are provided about the bulkhead connector end wall 134e for receiving screw fasteners 192, which will be used to fixedly mount the bulkhead connector 134 to a spa shell bulkhead 206 of the filter compartment 202 of the spa 200 (FIG. 1C), or on the wall of a swimming pool (not shown). The female electrical connector 142c that contains the plurality of metal electrical connection pin receptacles 142mr extends through an opening 194 (FIGS. 7D and 7F) of the spa shell bulkhead 206 of the filter compartment 202 of the spa 200 (FIG. 1C), or on the wall of a swimming pool (not shown) when the bulkhead connector 134 is fixedly mounted the spa shell bulkhead 206 of the filter compartment 202 of the spa 200 (FIG. 1C), or on the wall of a swimming pool (not shown).

The sidewall 134s of the bulkhead connector 134 has a pair of J-shaped locking slots 136. The locking slots 136 are disposed about 180 degrees opposite to one another in the bulkhead connector sidewall 134s. Each of the J-shaped locking slots 136 includes an open end 136o and a closed end 136c. The open ends 136o of the locking slots 136 are formed in a peripheral free edge 134fe of the bulkhead connector sidewall 134.

As best shown in FIGS. 7D and 7F, the J-shaped locking slots 136 of the bulkhead connector 134 and the locking pins of 132p of the chlorinator connector cap member 132m, are sized to permit the chlorinator connector cap member locking pins 132p to enter, and traverse the length of the bulkhead connector locking slots 186 to securely lock the chlorinator connector 132 of the chlorinator connector assembly 130 with the bulkhead connector 134 of the chlorinator connector assembly 130. More specifically, to electrically connect the chlorinator device 110 with the controller 150 during installation of the chlorinator device 110 in the filter compartment 202 of the spa 200, the locking pins 132p of the chlorinator connector cap member 132m are aligned with the open ends 136o of the locking slots 136 of the bulkhead connector 134. The chlorinator connector 132 is then pressed into the bulkhead connector 134 so that: 1) the cap member cylindrical sidewall 134s enters the space S between the chlorinator connector gasket 132g; 2) the chlorinator connector cap member sidewall 132s and the cap member locking pins 132 enter the bulkhead locking slots 136 through the open ends 136o thereof; and 3) the plurality of metal electrical connection pins 132mp of the chlorinator connector male electrical connector 132c enter and electrically connect with the metal electrical connection pin receptacles 142mr of the female electrical connector 142c of the first electrode cable 142, thereby electrically connecting the chlorinator device 110 with the controller 150 via the electrode cable assembly 140. The chlorinator connector cap member 132m is then rotated a few degrees in the direction of the closed ends 136c of the bulkhead locking slots 136 using the finger gripping members 132g of the cap member top wall 132t, so that the cap member locking pins 132p travel towards and abut against the closed ends 186c of the bulkhead locking slots 186, thereby locking the chlorinator connector 132 securely with the bulkhead connector 134. D

One of ordinary skill in the art will recognize that the above-described connection steps are reversed to electrically disconnect the chlorinator device 110 from the controller 150 during removal/replacement of the chlorinator device 110 from the filter compartment 202 of the spa 200.

As described earlier, the microprocessor 156 of the controller 150 monitors changes in the electrical energy signals received from the chlorine sensor 126 and thus, can detect when sanitizer is needed in the water, and energizes the electrodes 118 of the chlorinator device 110 for a chlorine production cycle.

One limitation of the current chlorine sensors is that the electrical signals can unintentionally vary based on water conditions, such as pH, alkalinity, mineral levels, etc. The measurement variations created by these water conditions cannot be reasonably predicted in advance, meaning the user must determine how to optimize the system performance for their specific circumstances by interacting with the following variables: 1) the length of the sanitizer/chlorine production cycle (known as the "Power Level") is user-adjustable from 1-9 hours; 2) a pause is inserted between sanitizer/chlorine production cycles, which increases from 30 minutes to three hours based on the length of the sanitizer/chlorine production cycle - the length of the pause is not user-adjustable, and the user is typically unaware that the pause exists; and 3) determining when to begin the next chlorine generation cycle is based on a millivolt reading from the sensor (known as the "Zero Point") - the Zero Point setting is user-adjustable from 10-150 millivolts, with higher values meaning the next sanitizer/chlorine production cycle will begin sooner.

Several issues have been noted with this method of operating a water care system: 1) it is confusing and frustrating for the user to determine the optimal settings of the two variables (Power Level and Zero Point) - as a result, users can inadvertently create system operation imbalances that negatively affect water conditions; 2) lack of transparency regarding the pause between sanitizer/chlorine generation cycles means users may unknowingly create unsafe water conditions at certain combinations of Power Level and Zero Point settings; 3) longer Power Level settings can inadvertently cause over-chlorination of the water in a single chlorine production cycle. The aforementioned issues of time and input required to fine tune the system's performance for the user's specific water conditions means the system is not as hands-off and easy-to-use as desired.

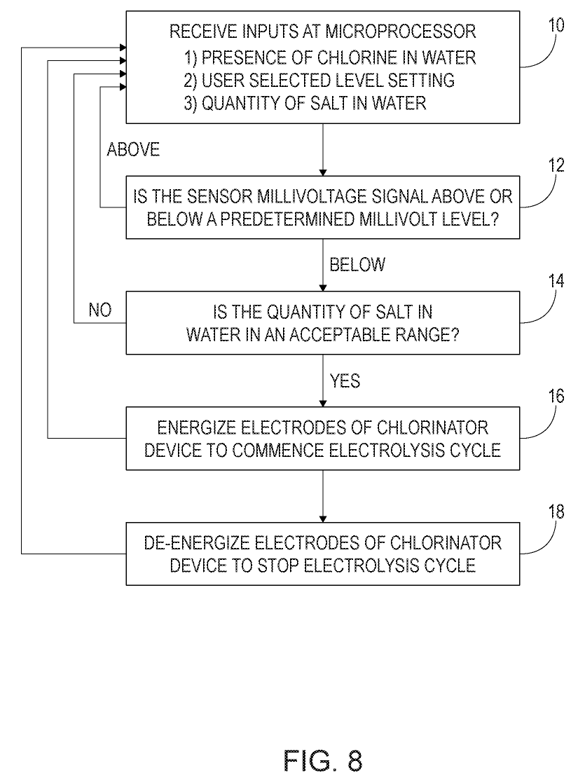

FIG. 8 is a flowchart which represents an illustrative embodiment of a method for operating the water care system of the present disclosure. The method represented by the flowchart in FIG. 8 substantially addresses the operating issues mentioned immediately above.

Referring now to box 10 of the flowchart, the microprocessor 156 of the controller 150 continuously receives the following input parameters: 1) presence of sanitizer/chlorine in the water of spa or pool measured by with the chlorine sensor (e.g., FIG. 2B, chlorine sensor 126) and reported as a millivolt (mV) signal (i.e., the quantity of the mV signal represents the presence or absence of sanitizer/chlorine as measured by the chlorine sensor in the water of the spa or pool at any given time); 2) a user-adjustable Level setting; and 3) quantity of electrolytic compounds (salt) is present in the water of the spa or pool, which is available to support the electrolysis process that generates the sanitizer/chlorine. In one embodiment, the quantity of salt is measured as an amperage signal. A constant 5 volts is applied to the electrodes 118, and the resulting amperage is measured and evaluated against an empirical conversion table that relates amperage to salt concentration. The user-adjustable Level setting comprises a single Level setting comprising a predetermined Power Level value (the time duration or length of the sanitizer/chlorine production cycle in hours), a predetermined Zero Point value of the chlorine sensor in millivolts (i.e., the mV value of the chlorine sensor when the next chlorine generation cycle should commence), and a predetermined Pause or Time Interval value in hours inserted between sanitizer/chlorine production cycles. A plurality of single Level settings are provided to the user in the present disclosure. The plurality of single Level settings provide the most effective balance among the Power Level, Zero Point, and Pause parameters to provide optimal water sanitization over a wide variety of operational conditions. In one embodiment, the plurality of Level settings can include 10 Level settings 1, 2, 3, 4, 5, 6, 7, 8, 9, and 10, wherein with lower level settings, such as Level settings 1, 2, 3, etc., correspond to lower sanitizer/chlorine output, and higher Level settings 6, 7, 8, etc., correspond to higher sanitizer/chlorine output. In one illustrative, embodiment, Level setting 1 can correspond to a chlorine sensor measurement of 10 mV, a Power Level of 1 hour, and a Pause time of 3 hours, and a Level setting 10 can correspond to 150 mV, a Power Level of 10 hours, and a Pause time of 1 hour.

In box 12 of the flowchart, the microprocessor 156 of the controller 150 determines whether the sensor mV signal is above or below the predetermined mV value of the Level setting selected by the user. If the microprocessor 156 determines in box 12 that the sensor mV signal is above the predetermined mV value of the Level setting selected by the user, then the microprocessor 156 maintains the system at idle and the method returns to boxes 10 and 12.

If, however, the microprocessor 156 of the controller 150 determines in box 12 that the sensor mV signal has fallen below the predetermined mV value of the Level setting selected by the user, then the microprocessor 156 determines in box 14 whether the quantity of the electrolytic compound (salt) in the water of the spa or pool is within an acceptable range for electrolysis, which in one non-limiting embodiment can be 0-1.41 amps, to commence in the chlorinator device 110. If the microprocessor 156 determines in box 14 that the quantity of the electrolytic compound (salt) in the water of the spa or pool is within an acceptable range, then the microprocessor 156 in box 16 causes the power supply 158 to energize the electrodes 118 of the chlorinator device 110 to commence electrolysis within the chlorinator device 110 for the duration of the sanitizer/chlorine production cycle defined as part of the user-adjustable Level setting. The electrolysis process operates with a fixed voltage and variable current (amperage), which in one non-limiting embodiment, includes a fixed voltage of 5 volts, and an amperage that varies between 0.8 - 1.2 amps. Once the sanitizer/chlorine production cycle has finished, the microprocessor 156 in box 18 causes the power supply to de-energize the electrodes 118 of the chlorinator device 110 to stop electrolysis within the chlorinator device 110, and the method returns to boxes 10 and 12. In box 12, the microprocessor 156 determines if the sensor mV signal is above the predetermined mV value of the Level setting selected by the user. If yes, then the system returns to idle. If no, then the system will commence another sanitizer/chlorine production cycle.

If, however, the microprocessor 156 of the controller 150 determines in box 12 that the sensor mV signal has fallen below the predetermined mV value of the Level setting selected by the user, but determines in box 14 that the quantity of the electrolytic compound (salt) is not within an acceptable range, then the microprocessor 156 maintains the system at idle to prevent a chlorination cycle from running until the user adjusts the quantity of the electrolytic compound (salt), so that it is within the acceptable range and the method returns to boxes 10 and 12. The quantity of the electrolytic compound can be reduced by draining a portion of the spa or pool water, and then refilling/replacing the water that was drained (without adding more salt in the water). This effectively dilutes the salt concentration so it can return to an acceptable range. Once the quantity of the electrolytic compound (salt) has been adjusted to be within the acceptable range, the microprocessor 156 has determined in box 12 that the sensor mV signal is below the predetermined mV value of the Level setting selected by the user, and the microprocessor 156 has determined in box 14 that the quantity of the electrolytic compound (salt) is now within an acceptable range, then in box 16 the microprocessor 156 causes the power supply to energize the electrodes 118 of the chlorinator device 110 to commence electrolysis with the chlorinator device 110 for the duration of the sanitizer/chlorine production cycle defined as part of the user-adjustable Level setting. Once the sanitizer/chlorine production cycle has finished, the microprocessor 156 in box 18 causes the power supply to de-energize the electrodes 118 of the chlorinator device 110 to stop electrolysis within the chlorinator device 110, and the method returns to boxes 10 and 12. In box 12, the microprocessor 156 determines if the sensor mV signal is above the predetermined mV value of the Level setting selected by the user. If yes, then the system returns to idle. If no, then the system will commence another sanitizer/chlorine production cycle.

In one embodiment, the system settings and the status are communicated to the user via a Bluetooth and/or a Wi-Fi connection, to a mobile app.

As one of ordinary skill in the art will recognize, the user only needs to adjust one variable, i.e., the Level setting, to optimize the system performance for their specific water conditions, making its operation simpler, easier, and more intuitive.

It should be understood that the invention is not limited to the embodiments illustrated and described herein. Rather, the appended claims should be construed broadly to include other variants and embodiments of the invention, which may be made by those skilled in the art without departing from the scope and range of equivalents of the invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. A water care system for regulating an amount of sanitizer in salt water contained in a spa or swimming pool, comprising:
a chlorinator device comprising at least two electrodes, which when energized in the salt water, generate the sanitizer via electrolysis;
a controller comprising a microprocessor and a power supply, the microprocessor selectively causing the power supply to energize the at least two electrodes of the chlorinator device when the quantity of chlorine drops below a predetermined threshold amount; and
a mounting socket for fixedly attaching to a floor or wall of the spa or pool, the mounting socket for removably positioning the chlorinator device on the floor or wall of the spa or pool.

2. The water care system of claim 1, further comprising a chlorinator connector assembly for connecting the chlorinator device with the power supply of the controller and disconnecting the chlorinator device from the power supply of the controller, the chlorinator connector assembly comprising:
a bulkhead connector; and
a chlorinator connector for releasably connecting with the bulkhead connector;
wherein the bulkhead connector is for fixedly attaching to a bulkhead of the spa or pool and electrically connected with the power supply of the controller; and
wherein the chlorinator connector is electrically connected with the at least two electrodes of the chlorinator device.

3. The water care system of claim 2, wherein the chlorinator connector includes a first electrical connector electrically connected with the electrodes and the bulkhead connector includes a second electrical connector electrically connected to the power supply of the controller, wherein the first and second electrical connectors are configured to connect with one another when the chlorinator connector is connected with the bulkhead connector.

4. The water care system of claim 2, further comprising an electrode cable assembly for electrically connecting the bulkhead connector with the power supply of the controller.

5. The water care system of claim 4, wherein the electrode cable assembly includes a first electrode cable, an electrode cable extension and the second electrode cable.

6. The water care system of claim 1, wherein the chlorinator device further comprises:
an electrode tube having first and second open ends and a plurality of water inlet/outlet openings extending through a sidewall of the electrode tube, the electrode tube enclosing the at least two electrodes; and
first and second caps each of which closes one of the first and second open ends of the electrode tube;
wherein one of the first and second caps includes a projecting locking member.

7. The water care system of claim 6, wherein the mounting socket includes a locking slot for releasably receiving the locking projection of the one of the first and second caps when the chlorinator device is mounted in the mounting socket, and wherein the projecting locking member and locking slot removably retain the chlorinator device in the mounting socket.

8. The water care system of claim 7, wherein the mounting socket further includes a tube-shape projection, the tube-shape projection including a detent for fixedly attaching the mounting socket to the floor or wall of the spa or pool.

9. The water care system of claim 6, wherein the electrode tube includes at least one series of a repeating pattern of the openings.

10. The water care system of claim 9, wherein the openings of the at least one series include a single elongated opening that extends transversely relative to a longitudinal axis L of the electrode tube axially followed by two spaced apart elongated openings, which extend transversely to the longitudinal axis of the electrode tube and are each shorter than the single elongated opening.

11. A chlorinator device for regulating an amount of sanitizer in salt water contained in a spa or swimming pool, comprising:
at least two electrodes, which when energized in the salt water, generate the sanitizer via electrolysis;
an electrode tube having first and second open ends, the electrode tube for enclosing the at least two electrodes; and
first and second end caps each of which closes one of the first and second open ends of the electrode tube;
wherein one of the first and second caps includes a projecting locking member for releasably engaging a locking slot of a mounting socket that removably positions the chlorinator device on the floor or wall of the spa or pool.

12. The chlorinator device of claim 11, wherein the electrode tube includes at least one series of a repeating pattern of the openings.

13. The chlorinator device of claim 12, wherein the openings of the at least one series include a single elongated opening that extends transversely relative to a longitudinal axis L of the electrode tube axially followed by two spaced apart elongated openings, which extend transversely to the longitudinal axis of the electrode tube and are each shorter than the single elongated opening.

14. The chlorinator device of claim 11, further comprising a chlorinator connector of a chlorinator connector assembly, the chlorinator connector assembly for connecting the chlorinator device with a power supply of a controller and disconnecting the chlorinator device from the power supply of the controller.

15. The chlorinator device of claim 14, wherein the chlorinator connector is electrically connected with the at least two electrodes of the chlorinator device.

16. The chlorinator device of claim 14, wherein the chlorinator connector is configured for releasably connecting with a bulkhead connector of the chlorinator connector assembly which is electrically connected with the power supply of the controller.

17. The chlorinator device of claim 16, wherein the chlorinator connector includes a first electrical connector electrically connected with the electrodes, the first electrical connector for connecting with a second electrical connector of the bulkhead connector when the chlorinator connector is connected with the bulkhead connector.

18. A method for operating the water care system, the method comprising:
inputting into a controller of the water care system a sensor signal indicating a presence or an absence of sanitizer in water of spa or pool;
inputting into the controller a selected level setting;
inputting into the controller a quantity of an electrolytic compound that is present in the water of the spa or pool;
determining with the controller whether the sensor signal has fallen below a predetermined sensor signal value of the level setting, wherein if the sensor signal has fallen below a predetermined sensor signal value of the level setting there is the absence of sanitizer in water of spa or pool and if the sensor signal is above a predetermined sensor signal value of the Level setting there is the presence of sanitizer in water of spa or pool;
determining with the controller whether the quantity of the electrolytic compound in the water of the spa or pool is within an acceptable range for electrolysis; and
if the controller determines that the sensor signal has fallen below a predetermined sensor signal value of the level setting and the quantity of the electrolytic compound in the water of the spa or pool is within the acceptable range, then the controller causes a chlorinator device of the water care system to commence electrolysis for a duration of a sanitizer production cycle defined as part of the selected Level setting.

19. The method of claim 18, further comprising causing the chlorinator device to stop sanitizer production with the controller if the duration of the sanitizer production cycle has ended.

20. The method of claim 18, wherein the selected level setting comprises a predetermined power level value, a predetermined zero point value of the sensor signal, and a predetermined pause value.

21. The method of claim 18, further comprising if the controller determines that the sensor signal above a predetermined sensor signal value of the level setting, the controller will not cause the chlorinator device to commence electrolysis for a duration of the sanitizer production cycle defined as part of the selected level setting.

22. The method of claim 18, further comprising if the controller determined that the quantity of the electrolytic compound in the water of the spa or pool is not within the acceptable range, then the controller will not cause the chlorinator device to commence electrolysis for the duration of a sanitizer production cycle defined as part of the selected level setting.
